(19) United States
(12) Patent Application Publication
(10) Pub. No.: US 2005/0080367 A1
(43) Pub. Date: Apr. 14, 2005

(54) Pressurizing compression apparatus for body part extremities

(76) Inventors: Phillip March, Zeeland, MI (US); Brad Kuipers, Holland, MI (US); Ellen Van't Hof, Holland, MI (US)

Correspondence Address: King & Jovanovic, PLC, 170 College Avenue, SUITE 230, HOLLAND, MI, 49423, US

(21) Appl. No.: 10/870,712

(22) Filed: Jun. 17, 2004

Related U.S. Application Data
(60) Provisional application No. 60/479,562, filed on Jun. 18, 2003.

(51) Int. Cl. A61H 23/00

(52) U.S. Cl. 601/148; 602/75

(57) ABSTRACT

A pressurizing compression device capable of providing pressure to a body extremity. The pressurizing compression device comprising a flexible wrap material and means for creating a pressure gradient. The flexible wrap material includes an upper end, a lower end and opposing side edges. The opposing side edges are positioned in proximity of each other so as to define a flexible wrap which is capable of surrounding a body extremity of a patient. The pressure gradient creating means creates a pressure gradient at least partially along the flexible wrap which decreases from the lower end to the upper end.

### CROSS REFERENCE TO RELATED APPLICATION

This application claims the benefit of U.S. Provisional Patent Application No. 60/479,562 filed Jun. 18, 2004, the entire specification of which is incorporated by reference.

### BACKGROUND OF THE INVENTION

1. Field of the Invention

The present invention relates in general to a body compression apparatus and more particularly, to a pressurizing compression apparatus for body part extremities. In particular, such a pressurizing compression apparatus is exceedingly useful for patients whose bodies retain fluid and which have a difficulty relative to the removal of fluid from the body.

2. Background Art

As medical research advances, the survivability of various diseases increases. For example, the survivability of breast cancer has increased greatly over the last decade. With advances in the survivability of such diseases, many conditions have arisen or have become exacerbated. For example, advances have led to the increased survival rate for sufferers of breast cancer. The survivors often have lymph nodes removed during their life saving operations. In turn, the body function regulating the transfer of fluids and waste from the body is impaired. As a result, the body tends to retain fluids at an increased rate. The fluid generally collects or pools proximate the extremities, leading to disastrous bloating and disfigurement.

To combat the collection and pooling of fluid, certain sleeves and wraps have been developed to apply pressure and compression to the body limbs to aid with the removal of fluid. The developed sleeves and wraps, while helpful, suffer from certain drawbacks. For example, the sleeves are generally exceedingly difficult to apply and remove. Moreover, inasmuch as the sleeve is generally a unitary device, it is difficult to address localized discomfort without removing the entire sleeve. Furthermore, if a user does not use the sleeve for even a short period of time, the collected fluid precludes the use of the sleeve, and a first larger sleeve must be used. In turn, the user must often have a full series of sleeves depending on the condition of the extremity on any given day.

With respect to wraps, such wraps are often difficult and time consuming to apply and dress. Moreover, a localized discomfort generally results in the removal and rewrapping of the entire band. Lastly, the wraps are often difficult to apply to lower extremities for users that lack dexterity. As such, the users who would benefit from the use of wraps are often reluctant to utilize same.

Accordingly, it is an object of the invention to provide for a pressurizing wrap for body extremities that overcomes the deficiencies of the prior art.

This an other objects will become apparent in light of the specification and claims appended hereto.

### BRIEF DESCRIPTION OF THE DRAWINGS

The invention will now be described with reference to the drawings wherein:

FIG. 1 of the drawings comprises a side elevational view of the invention, showing, in particular, the use thereof;

FIG. 2a of the drawings comprises a side elevational view of the invention, showing, in particular, the use thereof on an arm of a user;

FIG. 2b of the drawings comprises a side elevational view of the invention, showing, in particular, the use thereof on a leg of a user;

FIGS. 3a through 3c of the drawings comprise successive cross-sectional views of the invention taken generally along successive lines 3a-3a, 3b-3b and 3c-3c of FIG. 1;

FIG. 4 of the drawings comprises an exploded perspective view of the wrap member along with the pressure gradient means;

FIG. 5 of the drawings comprises a perspective view of the wrap member after attachment of the pressure gradient means to the wrap, but prior to assembly of the side edges into a wrap;

FIG. 6 of the drawings comprises a side elevational view of the invention, showing, in particular, an alternate pressure gradient means;

FIG. 7 of the drawings comprises a side elevational view of the invention, showing in particular, an alternate pressure gradient means;

FIG. 8 of the drawings comprises a partial side elevational view of the invention, showing, in particular, an alternate to the adjustment strap as utilized in association with the embodiment of FIG. 7; and

FIG. 9 of the drawings comprises a partial side elevational view of the invention, showing, in particular, an alternate to the adjustment strap as utilized in association with the embodiment of FIG. 7.

### SUMMARY OF THE INVENTION

The invention comprise a pressurizing compression device capable of providing pressure to a body extremity. The pressurizing compression device comprises a flexible wrap material and a pressure gradient creating means. The flexible wrap material includes an upper end, a lower end and opposing side edges. The opposing side edges are positioned in proximity of each other so as to define a flexible wrap which is capable of surrounding a body extremity of a patient. The pressure gradient creating means capable of creating a pressure gradient at least partially along the flexible wrap which decreases from the lower end to the upper end.

In a preferred embodiment, the pressure gradient creation means comprises a plurality of layers of material positioned over at least a portion of the flexible wrap material. The plurality of layers configured such that the number of layers decreases sequentially from the lower end of the flexible wrap material and the upper end of the flexible wrap material.

In one embodiment, the plurality of layers comprises at least a first layer, a second layer and a third layer. In one such embodiment, the first layer, second layer and third layer each include a substantially corresponding lower end positioned proximate the lower end of the flexible wrap. The first layer includes an upper end which extends proximate the upper end of the flexible wrap. The second layer includes an upper end which is spaced apart from the upper end of the first layer. The third layer includes an upper end which is spaced apart from the upper end of the second layer, such that each successive layer terminates farther away from the upper end of the wrap than a preceding layer.

In another preferred embodiment, each of the wrap and the plurality of layers comprise a material which is substantially elastic in a first transverse direction and substantially inelastic in a second longitudinal direction.

In another preferred embodiment, each of the plurality of layers are attached to at least one of another layer and the flexible wrap. Preferably, each of the plurality of layers are stitched to at least one of another layer and the flexible wrap.

In another embodiment, the pressure gradient creating means comprises a plurality of biasing members placed substantially sequentially along the flexible wrap between the lower end and the upper end thereof. Each biasing member comprises a first end attached to a first portion of the flexible wrap and a second end attached to a second portion of the flexible wrap. The first portion is separated from the second portion a predetermined transverse distance so as to bias the portions toward each other. The force exerted by the biasing members decreases from the lower end to the upper end of the flexible wrap.

In another embodiment, the biasing members comprises a plurality of biasing member groups, each of the plurality of biasing members each having a plurality of biasing members, each exerting substantially the same force. In another such embodiment, each of the biasing member groups includes at least three biasing members.

In yet another embodiment, the pressure gradient creating means comprises a plurality of adjustment straps positioned at discrete points along the flexible wrap materials.

In one embodiment, each of the plurality of adjustment straps each include a first strap component and a second loop component. The first strap component and the second loop component interface so as to provide pressure to a body extremity of a user.

In another preferred embodiment, the pressure gradient creating means comprises a plurality of draw strings which extend between at least two transversely spaced apart points on the flexible wrap, to, in turn, provide pressure to a body extremity of a user.

In another preferred embodiment, the draw strings comprise elastic draw strings. In another preferred embodiment, each of the draw strings includes a different elasticity, to, in turn, foster a pressure gradient.

### DETAILED DESCRIPTION OF THE INVENTION

While this invention is susceptible of embodiment in many different forms, there is shown in the drawings several specific embodiments with the understanding that the present disclosure is to be considered as an exemplification of the principles of the invention and is not intended to limit the invention to the embodiments illustrated.

It will be understood that like or analogous elements and/or components, referred to herein, are identified throughout the drawings by like reference characters. In addition, it will be understood that the drawings are merely representations of the present invention, and some of the components may have been distorted from actual scale for purposes of pictorial clarity.

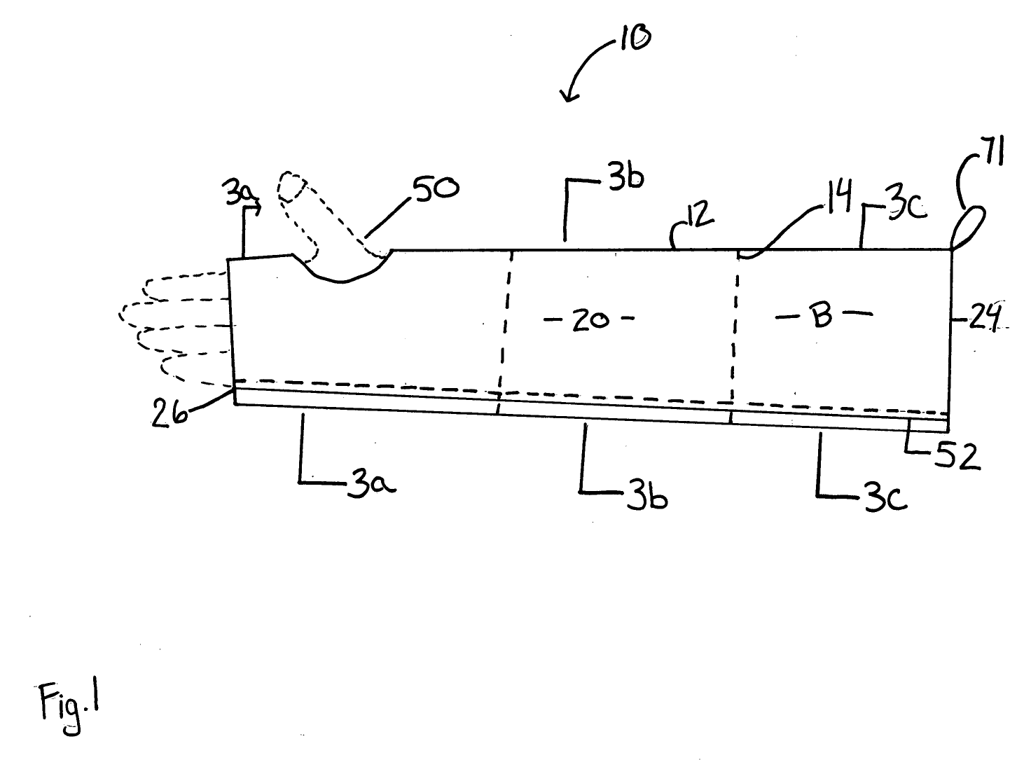

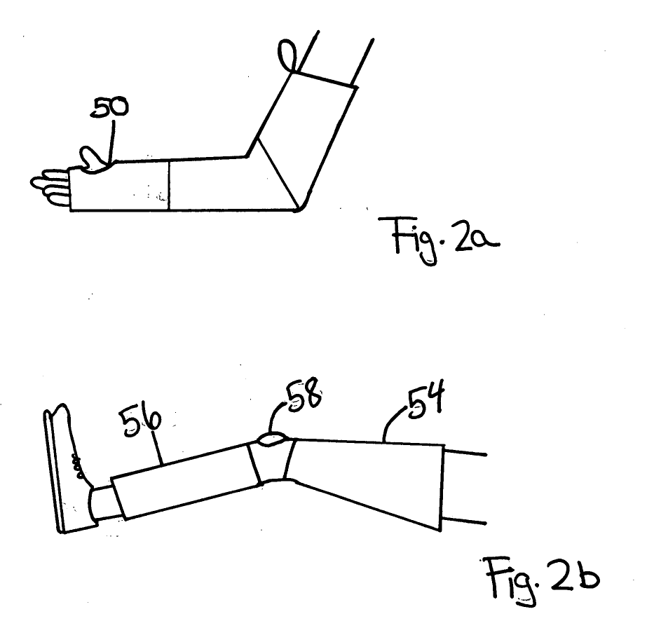

Referring now to the Figures, and in particular to FIG. 1, pressurizing compression apparatus 10 is shown as comprising outer wrap material 12 and means 14 for creating a pressure gradient at least partially along the length of the wrap material between the upper and lower ends thereof. The pressurizing compression apparatus is well suited for application onto different extremities of a user. For example, the pressurizing compression device may be configured for use with an arm of a user (FIG. 2a) or a leg of a user (FIG. 2b). Of course, the wrap is not limited to those uses.

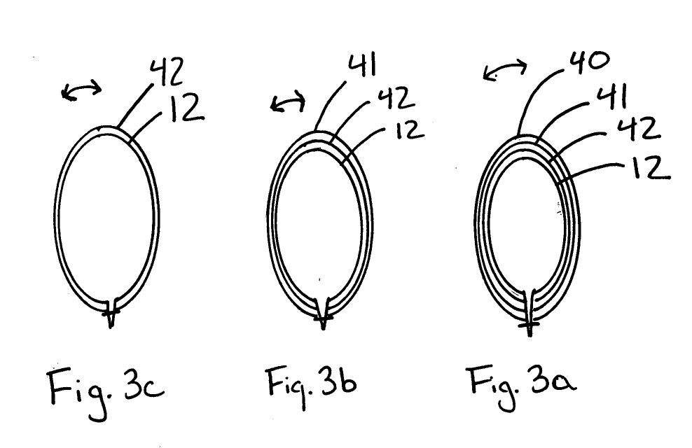

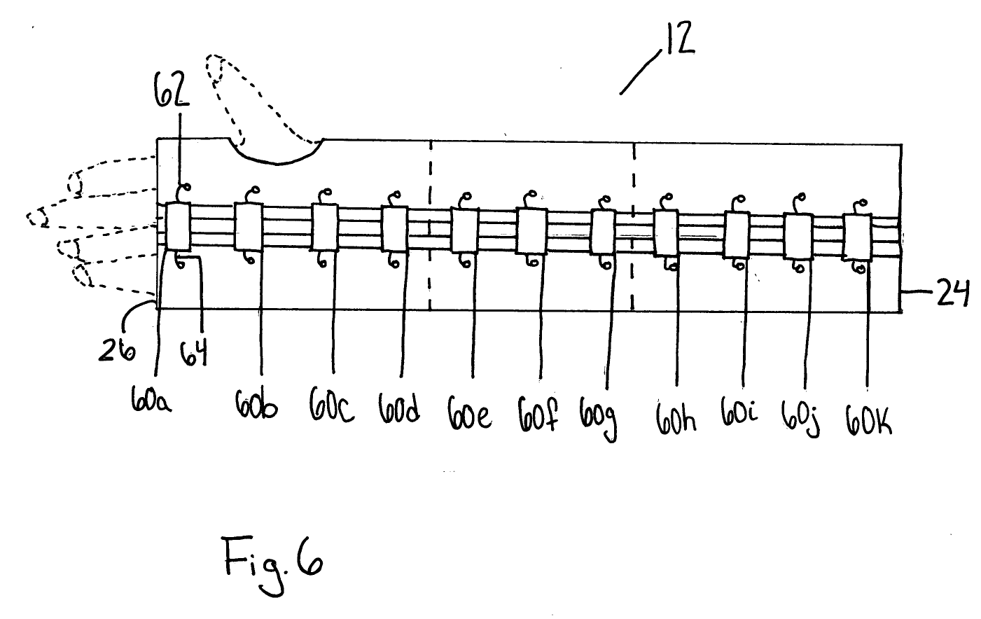

With reference to FIG. 1, outer wrap material 12 comprises a flexible, elastic-like material which is capable of elastic deformation. In the embodiment shown, outer wrap material 12 includes outer surface 20, an inner surface 22 (FIGS. 3a through 3d), upper end 24, lower end 26 and side edges 28, 29 (FIG. 5). The inner surface contacts the patients skin, whereas outer surface material is exposed to the elements. The upper end 24 opposes the lower end 26 and the side edges meet when the outer wrap material is stitched together to form the wrap.

The outer wrap material is configured to substantially mimic the outer configuration of the particular extremity. For example, with reference to FIG. 1, the outer wrap that is configured for use in association with an arm of a user includes structures such as thumb opening 50 proximate the first end and generally has a larger diameter toward the second end thereof, as the upper arm is generally of a greater dimension than the lower arm. In various embodiments, it is contemplated that the device may be provided in a single size, and, subsequently, after the side edges 28, 29 are joined to form a wrap, stitch 52 can be introduced so as to alter the internal dimensions thereof, and to custom fit a particular user. Of course, stitch 52 can be used as the mechanism by which to form the wrap by abutting side edges 28, 29.

Another such outer wrap material intended for use in association with a leg includes a first portion 54 configured for use around the upper leg, a second portion 56 configured for use around a lower leg, and a third portion 58 positioned therebetween designed for use around the knee region (and configured for movement of the knee). The outer wrap material is generally sized so as to extend around the outer surface of the user's extremity. The wrap may include one or more zippers or other fasteners, such as buttons or snaps which facilitate the placing of the wrap around the body of the user.

Such materials are commonly available in commercial wraps, such as bandages sold under the commercial name ACE. Other materials, which may be suitable for use comprise spandex based materials which are likewise capable of elastic deformation. Some of the most preferred materials suitable for use comprise elastic materials which are elastic when pulled in a first direction denoted by arrows a shown in FIG. 3, but substantially inelastic when pulled in a direction perpendicular to the first direction denoted by arrows β shown in FIG. 1. Another particularly interesting material comprises a multiply material comprising an inner cushioning material (such as a cotton based material, or a wicking material), a middle elastically deformable material and an outer material (spandex or the like). Such a material has enhanced features of wicking moisture from the body, compressing the body, yet having an outward appearance that is substantially more appealing than the compression type wraps.

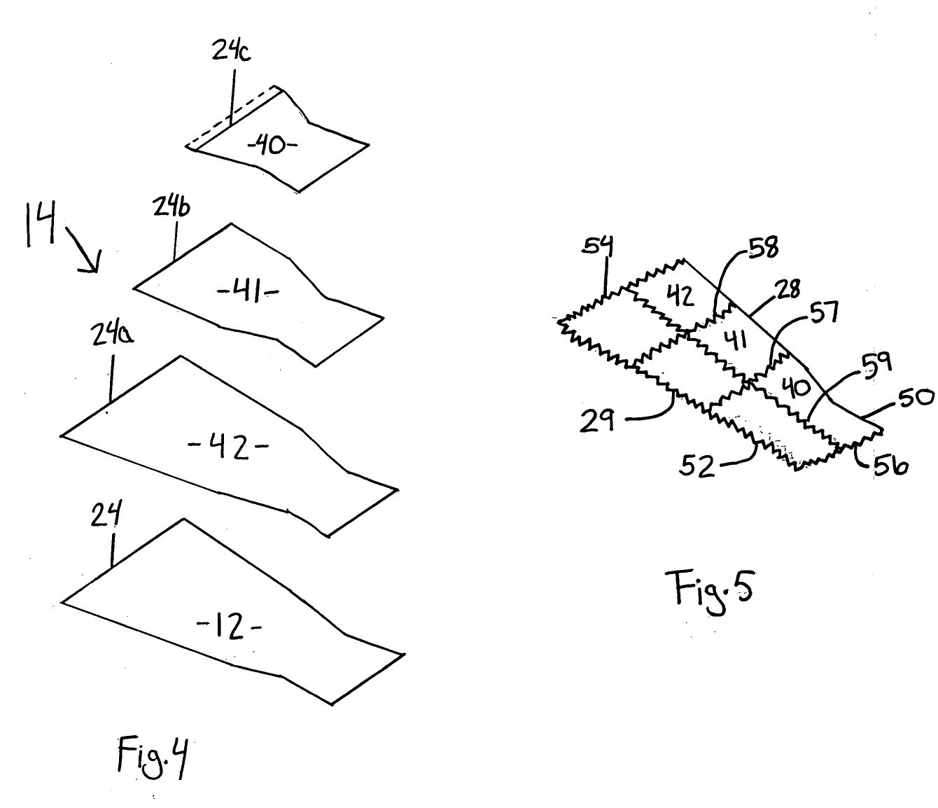

Pressure gradient creating means 14 are shown in FIGS. 3a through 3d as well as in FIGS. 4 and 5 as comprising a plurality of materials which extend over predetermined potions of wrap 12. In the embodiment shown, the layers comprise first layer 42, second layer 41 and third layer 40. The first layer is substantially coextensive with the inner surface of wrap 12. The second layer initiates proximate lower end 26 of wrap 12 and extends to second layer upper end 24b which is a distance spaced apart from upper end 24 of wrap 12. The third layer initiates proximate lower end 26 of wrap 12 and extends to third layer upper end 24c which is a distance spaced apart from second layer upper end 24b. As is shown in FIG. 5, the various layers are attached to each other and to wrap 12 by way of stitching 50 through 59. Indeed, other means are likewise contemplated such as heat sealing, glue, adhesive, etc.

Referring to FIGS. 3a through 3c three discrete thicknesses are created inasmuch as the upper region of the apparatus includes one layer of material along with wrap 12, the middle region of the apparatus includes two layers of material along with wrap 12 and the lower region of the apparatus includes three layers of material along with wrap 12. In turn, when worn by a user, the increase in the number of layers within the wrap from the upper end to the lower end provides a positive pressure gradient in an upward direction. It is contemplated that a greater or fewer number of layers can be utilized to create greater number or a fewer number of discrete regions. In other embodiments, a single layer having a varying thickness can be utilized in place of the separate layers. Such a single layer can have a continuous slope or a slope having discrete disconontinuances therein. In each such situation, the pressure gradient directs fluid away from the extremities and toward the main part of the body.

Referring now to FIG. 6, another embodiment is disclosed. In such an embodiment, pressure gradient 14 may comprise a plurality of biasing members 60 which are positioned along the length of wrap 12. Each biasing member 60a through 60k have a first end 62 attached to wrap 12 and a second end 64 attached to wrap 12 at a location transversely spaced apart from first end 62. The biasing members pull the respective ends toward each other so as to create a pressure upon the body component positioned within wrap 12. It is preferred that the biasing members comprise constant force springs of various different ratings. In such an embodiment, the force exerted by the springs can be increased from a first force rating of biasing member 60k proximate the upper end to a second force rating of biasing member 60a which is higher than the first force rating proximate the lower end of the wrap. In certain embodiments, each successive biasing member may have a slightly higher force rating, whereas in other embodiments a plurality of biasing members may comprise one of a plurality of regions, and the biasing members within each region may have a substantially identical force. For example, three regions may be created along wrap 12, a first region including biasing members 60h through 60k, a second region including biasing members 60e through 60g, and a third region including biasing members 60a through 60d. Preferably the biasing members are releasable so as to facilitate the washing of the wrap.

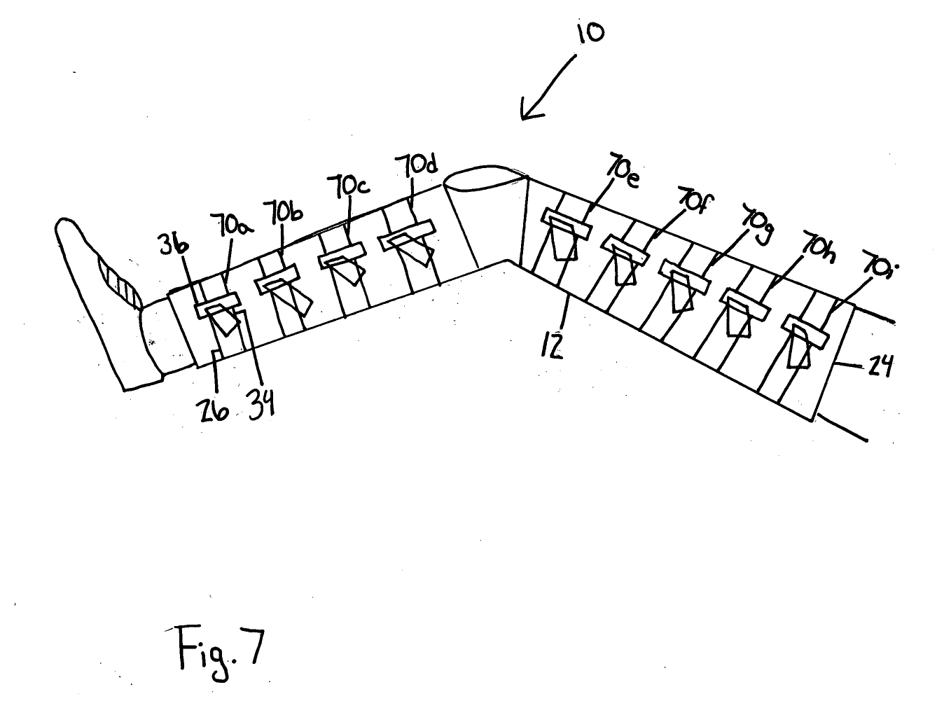

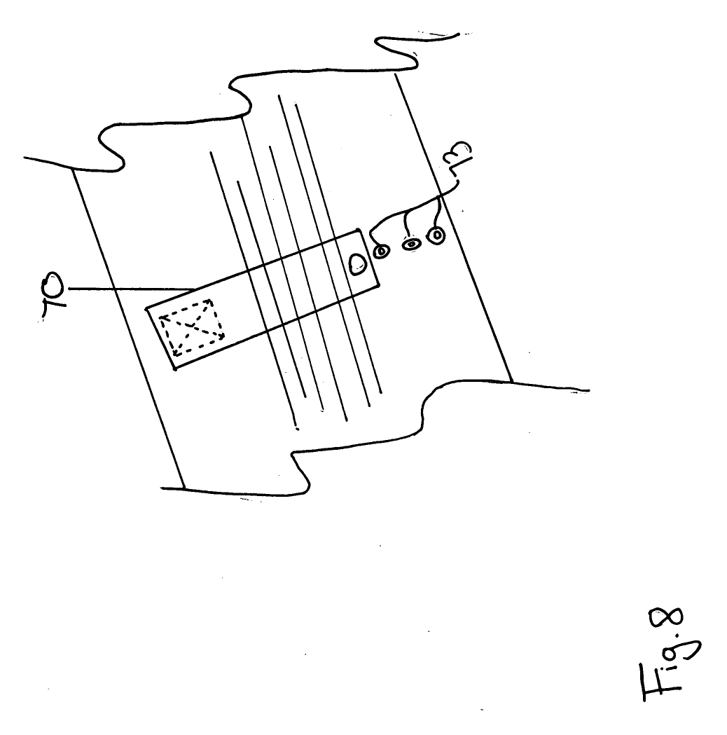

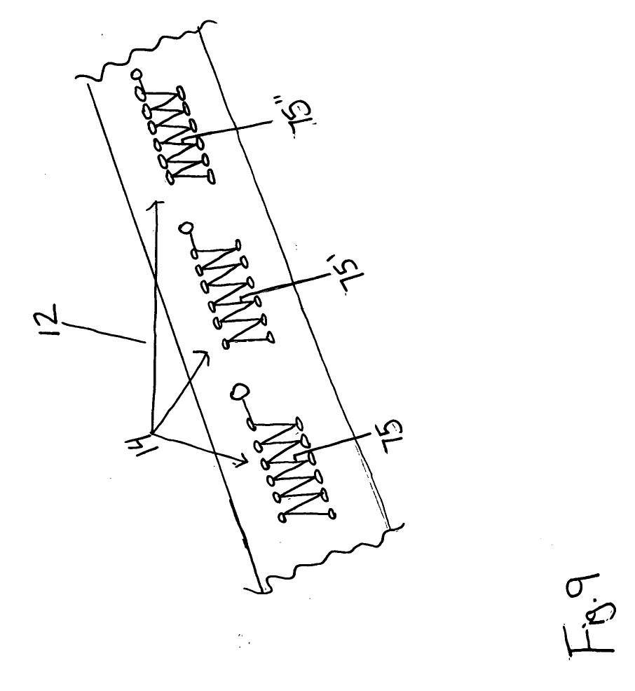

Referring now to FIG. 7, another embodiment of the apparatus is disclosed. In such an embodiment, the pressure gradient means may comprise adjustment straps, such as adjustment strap 70 as comprising a plurality of elements positioned at discrete points along the flexible wrap material from the upper end thereof to the lower end thereof. Each adjustment strap includes a first strap component 34 and a second loop component 36. The first strap component 34 is attached proximate one of side edges 28 and side edges 29. The loop component 36 is attached proximate the other of side edges 28 and 29. The first strap is lined with both hook and loop fasteners at strategic positions. In turn, the strap component can be looped through the loop component and fastened to itself. The strap component can be pulled tighter or looser prior to attachment to increase or decrease the distance between the components and the effective length of the strap. Of course, a number of components are contemplated for use in place of the aforementioned strap component and loop component. For example, adjustment straps each having a plurality of successive fasteners 73 (such as the fastener shown in FIG. 8), draw strings 75, 75′, 75″(both elastic and inelastic as shown in FIG. 9), as well as other hook and loop fastening systems can be employed to facilitate the compression of the underlying flexible wrap material. With draw strings each successive draw string 75, 75′ and 75″ may comprise a draw string of differing elasticity.

By altering the force with which the adjustment members are employed, the user can create a pressure gradient from one end to the other end. Further, indicators may be positioned on the first strap component to provide visual indication to the user as to the relative position of each of the adjustment straps. Moreover, the adjustment straps may include attachment points which facilitate the attachment thereof to a force sensing device (such as a spring based scale). In turn, the user can set the force with which the straps compress to a particular desired setting (which is repeatable with successive applications).

Advantageously, a patient can apply, remove, reapply the apparatus without the help of others. In particular, with the embodiments of FIG. 1, such an embodiment can be slipped onto the extremity. In certain embodiments, such as the embodiment of FIG. 1, pull member 71 can be attached to an outside structure to provide a resistance against which the user can work so as to position the device on the extremity. In other embodiments, the zippers or other attachment mechanisms can facilitate the application of the apparatus by the user.

Moreover, due to the adjustment properties, a user can utilize the device through a broad range of conditions (i.e., various degrees of bloating and water retention). Furthermore, the user is capable of accessing localized regions of discomfort and treating such regions. For example, if a sore develops in a region covered by the flexible wrap material, the user can remove a portion of the flexible wrap material, apply a bandage or an ointment to the area, and quickly reapply the flexible wrap material. Further still, through the wide range of adjustments, the user is capable of wearing the apparatus for extended periods of time and while doing a wide range of activities. Of course, additional advantages will be apparent in light of the specification provided herein.

The foregoing description merely explains and illustrates the invention and the invention is not limited thereto except insofar as the appended claims are so limited, as those skilled in the art who have the disclosure before them will be able to make modifications without departing the scope of the invention.

1. A pressurizing compression device capable of providing pressure to a body extremity, the pressurizing compression device comprising:
a flexible wrap material having a upper end, a lower end and opposing side edges, the opposing side edges being positioned in proximity of each other so as to define a flexible wrap which is capable of surrounding a body extremity of a patient;
means for creating a pressure gradient at least partially along the flexible wrap which decreases from the lower end to the upper end.

2. The pressurizing compression device of claim 1 wherein the pressure gradient creation means comprises a plurality of layers of material positioned over at least a portion of the flexible wrap material, the plurality of layers configured such that the number of layers decreases sequentially from the lower end of the flexible wrap material and the upper end of the flexible wrap material.

3. The pressurizing compression device of claim 2 wherein the plurality of layers comprises at least a first layer, a second layer and a third layer.

4. The pressurizing compression device of claim 3 wherein the first layer, second layer and third layer each include a substantially corresponding lower end positioned proximate the lower end of the flexible wrap, the first layer includes an upper end which extends proximate the upper end of the flexible wrap, the second layer includes an upper end which is spaced apart from the upper end of the first layer, the third layer includes an upper end which is spaced apart from the upper end of the second layer, such that each successive layer terminates farther away from the upper end of the wrap than a preceding layer.

5. The pressurizing compression device of claim 2 wherein each of the wrap and the plurality of layers comprise a material which is substantially elastic in a first transverse direction and substantially inelastic in a second longitudinal direction.

6. The pressurizing compression device of claim 2 wherein each of the plurality of layers are attached to at least one of another layer and the flexible wrap.

7. The pressurizing compression device of claim 6 wherein each of the plurality of layers are stitched to at least one of another layer and the flexible wrap.

8. The pressurizing compression device of claim 1 wherein the pressure gradient creating means comprises a plurality of biasing members placed substantially sequentially along the flexible wrap between the lower end and the upper end thereof, each biasing member comprising:
a first end attached to a first portion of the flexible wrap; and
a second end attached to a second portion of the flexible wrap, the first portion separated from the second portion a predetermined transverse distance so as to bias the portions toward each other, wherein
the force exerted by the biasing members decreases from the lower end to the upper end of the flexible wrap.

9. The pressurizing compression device of claim 8 wherein the biasing members comprises a plurality of biasing member groups, each of the plurality of biasing members each having a plurality of biasing members, each exerting substantially the same force.

10. The pressurizing compression device of claim 9 wherein each of the biasing member groups includes at least three biasing members.

11. The pressurizing compression device of claim 1 wherein the pressure gradient creating means comprises a plurality of adjustment straps positioned at discrete points along the flexible wrap materials.

12. The pressurizing compression device of claim 11 wherein each of the plurality of adjustment straps each include a first strap component and a second loop component, the first strap component and the second loop component interfacing so as to provide pressure to a body extremity of a user.

13. The pressurizing compression device of claim 1 wherein the pressure gradient creating means comprises a plurality of draw strings which extend between at least two transversely spaced apart points on the flexible wrap, to, in turn, provide pressure to a body extremity of a user.

14. The pressurizing compression device of claim 13 wherein the draw strings comprise elastic draw strings.

15. The pressurizing compression device of claim 14 wherein each of the draw strings includes a different elasticity, to, in turn, foster a pressure gradient.
